(19) United States
(12) Patent Application Publication
(10) Pub. No.: US 2026/0243912 A1
(43) Pub. Date: Aug. 20, 2026

(54) SEISMIC RESILIENCE ASSESSMENT METHOD AND SYSTEM FOR RAILWAY GIRDER BRIDGE

(71) Applicant: Southwest Jiaotong University, Chengdu City (CN)

(72) Inventors: Canhui ZHAO, Chengdu City (CN); Wei KANG, Chengdu City (CN); Weitao YIN, Chengdu City (CN); Hao LU, Chengdu City (CN); Yonghao ZHOU, Chengdu City (CN); Jinhao LIANG, Chengdu City (CN); Hao ZENG, Chengdu City (CN); Pengju CHENG, Chengdu City (CN); Yihua LIU, Chengdu City (CN)

(21) Appl. No.: 19/540,777

(22) Filed: Feb. 15, 2026

(30) Foreign Application Priority Data
Feb. 14, 2025 (CN) 202510163175.2

(51) Int. Cl. G01V 1/36; G01V 1/30; G01V 1/38

(52) U.S. Cl. CPC G01V 1/364; G01V 1/306; G01V 1/3808

(57) ABSTRACT

Disclosed is a seismic resilience assessment method and system for a railway girder bridge in the technical field of bridge engineering structures, which solves the technical problem of the absence of seismic resilience assessment methods applicable to railway bridges in the prior art. The method includes: a nonlinear finite element model of the entire bridge is established to perform vulnerability analysis; according to the vulnerability results, damage states of components and traffic functionality damage states are quantified by weighting damage probabilities; a post-earthquake repair time and functionality recovery values are determined to obtain post-earthquake traffic functionality recovery curves of the bridge; and resilience indices of the bridge is obtained ultimately and the bridge functional states are classified into three levels.

### TECHNICAL FIELD

The present disclosure relates to the technical field of bridge engineering structures, and particularly, to a seismic resilience assessment method and system for a railway girder bridge.

### BACKGROUND

The existing seismic design philosophy for bridge structure of “no damage under minor earthquakes, repairable under moderate earthquakes, and no collapse under major earthquakes” sets macro-level requirements for the seismic fortification standards of bridges. As critical rescue passages, the degree of functional loss and the time required for functional recovery after an earthquake are crucial to seismic emergency response. This is especially true for railway transportation networks, where bridges constitute a large proportion. The damage to railway bridges during a strong earthquake can directly compromise the traffic functionality of the entire railway line. Currently, seismic resilience assessment methods are primarily oriented toward building structures, such as GB/T 38591-2020 Standard for Seismic Resilience Assessment of Buildings and FEMA-P58. The application of seismic resilience assessment methods developed for building structures to the assessment of railway bridges presents the following problems: (1) there are significant differences between building structures and bridge structures. Damage and resilience assessment indicators designed for building structures cannot adequately characterize the specific damage features of bridges, requiring a reconstruction of the assessment indicator system. (2) The function of bridges is to ensure the safe passage of trains at designated speeds, whereas buildings mainly focus on ensuring personnel safety and supporting auxiliary functions (e.g., hospital buildings ensure the provision of medical services). Therefore, the quantification of post-earthquake function for railway bridges needs to be redefined. (3) Building resilience levels comprehensively considers repair costs, repair time, and casualties, which is not entirely applicable to railway bridges. Moreover, the commonly used composite resilience index, as a normalized quantity, cannot intuitively reflect the post-earthquake traffic functionality status. Therefore, the three problems described above require focused attention.

### SUMMARY

The present disclosure provides a seismic resilience assessment method and system for a railway girder bridge.

A seismic resilience assessment method for a railway girder bridge, includes:
step 1, a nonlinear finite element model of an entire bridge is established to simulate and output seismic responses of key bridge components; track alignment irregularity V is calculated on a basis of the seismic responses of the key bridge components and a beam-track deformation mapping relationship, where the key bridge components include piers, bearings, and tracks;
step 2, a logarithmic scatter plot between ground motion intensity and pier curvature ductility factor is established on a basis of pier analysis results under seismic waves; a logarithmic scatter plot between the ground motion intensity and bearing displacement is established on a basis of bearing analysis results under the seismic waves; a logarithmic scatter plot between the ground motion intensity and the track alignment irregularity V is established on a basis of track alignment irregularity analysis results under the seismic waves; and linear regression is performed on the three scatter plots above to establish probabilistic seismic demand models for responses of each key bridge component;
step 3, damage exceedance probabilities of each key bridge component under different damage states are calculated on a basis of the probabilistic seismic demand models for responses of each key bridge component; damage rate thresholds of each key bridge component are normalized on a basis of capacity thresholds; a bearing damage rate Q_{LB}, a pier damage rate Q_{LP}, and a bridge traffic functionality loss Q_{L} are calculated by weighting the damage exceedance probabilities and the damage rate thresholds; damage evolution curves of each key bridge component under varying ground motion intensities are established;
step 4, a post-earthquake bridge residual traffic functionality Qᵣ is obtained according to the traffic functionality loss Q_{L}; a post-earthquake component repair time Tᵣₑⱼ (j=1, 2, 3) is calculated; traffic functionality values Qᵣ₁, Qᵣ₂, and Qᵣ₃ after full recovery of each key bridge component are calculated; finally, post-earthquake traffic functionality recovery curves are established;
step 5, a seismic resilience index of a bridge is calculated; minimum ground motion intensities at which the bearings and the piers reach complete damage levels and minimum ground motion intensities at which the tracks reach slight damage and the complete damage levels are obtained on a basis of the damage evolution curves of each key bridge components and the post-earthquake traffic functionality recovery curves under varying ground motion intensities; boundary values of three seismic resilience levels of the bridge are determined on a basis of an ground motion intensity-seismic resilience index curve, i.e., normal passage, speed-restricted passage, and structural safety.

Further, the step 1 includes:
step 1.1, the nonlinear finite element model of the entire bridge is established according to bridge design parameters;
considering the nonlinear mechanical characteristics of the key bridge components, the bearings are simulated using nonlinear elements, the piers are simulated using nonlinear beam-column elements, and the main girders are simulated using beam elements;
step 1.2, a target response spectrum curve is determined according to site conditions of the bridge;
step 1.3, on a basis of the target response spectrum curve, no fewer than 60 seismic waves are selected from a PEER before inputting into the finite element model to perform nonlinear time-history analysis; and the intensity amplitude ratio of the three-directional seismic wave inputs is set to transverse: longitudinal: vertical=1.0:0.85:0.65;
at step 1.4, relative displacement of a main girder end at an expansion joint, bearing deformation, and curvature φ of the cross-section at the bottom of the pier are output as the seismic responses of the key bridge components, where the relative displacement of the main girder end at the expansion joint includes a peak displacement Dᵣ and a residual displacement Dₚ;
step 1.5, the track alignment irregularity V is calculated on a basis of the beam-track deformation mapping relationship.

Further, the track alignment irregularity V is calculated as follows:

$$V ( {D}_{p} , {D}_{r} ) = {g}_{4} ( {D}_{p} ) {D}_{r}^{4} + {g}_{3} ( {D}_{p} ) {D}_{r}^{3} + {g}_{2} ( {D}_{p} ) {D}_{r}^{2} + {g}_{1} ( {D}_{p} ) {D}_{r} + {g}_{0} ( {D}_{p} ) \{ \begin{matrix}{g}_{4} ( {D}_{p} ) = 1.946 \times 1 {0}^{- 7} \\ {g}_{3} ( {D}_{p} ) = - 2.091 \times 1 {0}^{- 7} {D}_{p} - 4.568 \times 1 {0}^{- 5} \\ {g}_{2} ( {D}_{p} ) = 2.247 \times 1 {0}^{- 8} {D}_{p}^{2} + 5.084 \times 1 {0}^{- 5} {D}_{p} + 0.002567 \\ {g}_{1} ( {D}_{p} ) = - 6.634 \times 1 {0}^{- 6} {D}_{p}^{2} - 0.002909 {D}_{p} + 0.5072 \\ {g}_{0} ( {D}_{p} ) = 1.234 \times 1 {0}^{- 4} {D}_{p}^{2} + 0.02334 {D}_{p} + 0.04164\end{matrix} , \qquad ( 1 )$$

where Dᵣ is the peak displacement, Dₚ is the residual displacement, and g₀ to g₄ are intermediate calculation parameters.

Further, the step 2 includes:
step 2.1, cross-sectional analysis at the bottom of the pier is performed to establish a cross-sectional strain-curvature curve, and an initial yield curvature φ₀ corresponding to yielding of longitudinal reinforcement of the pier is obtained;
step 2.2, a curvature ductility factor pc of the pier is calculated according to the curvature φ of the cross-section at the bottom of the pier under seismic action, as shown in Equation (2),

$${μ}_{c} = \frac{φ}{{φ}_{0}} ; \qquad ( 2 )$$

step 2.3, logarithms of the ground motion intensity of each ground motion, the bearing deformation of a model under the ground motion, the curvature ductility factor of the pier, and the track alignment irregularity V are taken, and a logarithmic scatter plot between the ground motion intensity (IM) and the seismic response (EDP) is established;
at step 2.4, linear regression is performed on the logarithmic scatter cloud plot to establish the probabilistic seismic demand models for bearings, piers, and track responses, as shown in Equation (3),

$$ln ( E D P ) = ln ( a ) + b ln ( I , M ) , \qquad ( 3 )$$

where a and b are the regression parameters of the probabilistic seismic demand model.

Further, the step 3 includes:
step 3.1, the damage states of the key bridge components are divided into five levels, including no damage, slight damage, moderate damage, severe damage, and complete damage, and control indicators corresponding to the damage states are determined, where the control indicator for the piers includes longitudinal reinforcement strain and concrete strain, the control indicator for the bearings includes bearing displacement, and the control indicator for the tracks includes track alignment irregularity;
step 3.2, vulnerability analysis is conducted as shown in Equations (4) to (5),

$$P = P ( E D P > {S}_{c} \vert IM ) = Φ ( \frac{ln ( E D P ) - ln ( {S}_{c} )}{\sqrt{{β}_{C}^{2} + {β}_{d}^{2}}} ) , \qquad ( 4 )$$

$${β}_{d} = \sqrt{\frac{{{\sum }_{i = 1}^{N} [ ln ( E D {P}_{i} ) - ( ln a + b \cdot ln ( IM ) ) ]}^{2}}{N - 2}} , \qquad ( 5 )$$

where S_{c} is a mean seismic capacity of the key bridge component; β_{c} is a logarithmic standard deviation of a seismic capacity of the key bridge component; β_{d} is a logarithmic standard deviation of the seismic response of the key bridge component; EDPᵢ is the seismic response under an action of an i-th seismic wave; N is a number of input seismic waves; IM is the ground motion intensity; EDP is the seismic response; and a and b are regression parameters of the probabilistic seismic demand model.

Further, the step 3 further includes:
step 3.3, the damage rate thresholds L1ᵢ, L2ᵢ, and L3ᵢ are calculated for each key bridge component, where Equations (6) to (8) correspond to the bearings, the piers, and the tracks, respectively,

$$L {1}_{i} = \frac{{D}_{i}}{3.3 {D}_{c}} ( i = 1 , 2 , 3 , 4 ) , \qquad ( 6 )$$

$$L {2}_{i} = \frac{{μ}_{i}}{{μ}_{4}} ( i = 1 , 2 , 3 , 4 ) , \qquad ( 7 )$$

$$L {3}_{i} = \frac{{V}_{d \_ max} - {V}_{r}}{{V}_{d \_ max} - {V}_{min}} ( i = 1 , 2 , 3 , 4 ) , \qquad ( 8 )$$

where D_{c} is an allowable seismic displacement of the bearing; Dᵢ is a bearing deformation threshold for an i-th damage state of the bearing; μᵢ is a sectional curvature ductility factor for an i-th damage state of the pier; V_{d_max} is a maximum design speed of a railway line, and Vₘᵢₙ is a design speed of the railway line; Vᵣ is a post-earthquake residual traffic speed; and μ4 is a ductility factor threshold for complete damage;
step 3.4, on a basis of the vulnerability analysis results, the bearing damage rate (Q_{LB}), the pier damage rate (Q_{LP}), and the bridge traffic functionality loss (Q_{L}) are calculated by weighting the damage exceedance probabilities, with reference to Equations (9) to (12),

$${Q}_{LB} = {\sum }_{i = 1}^{N} {P}_{f}^{( i )} L {1}_{i} ( i = 1 , 2 , 3 , 4 ) , \qquad ( 9 )$$

$${Q}_{L P} = {\sum }_{i = 1}^{N} {P}_{f}^{( i )} L {2}_{i} ( i = 1 , 2 , 3 , 4 ) , \qquad ( 10 )$$

$${Q}_{L} = {\sum }_{i = 1}^{N} {P}_{f}^{( i )} L {3}_{i} ( i = 1 , 2 , 3 , 4 ) , \qquad ( 11 )$$

$${P}_{f}^{( i )} = \{ \begin{matrix}\begin{matrix}\begin{matrix}{P}_{{DS}_{1}} - {P}_{{DS}_{2}} \\ {P}_{{DS}_{2}} - {P}_{{DS}_{3}}\end{matrix} \\ \begin{matrix}{P}_{{DS}_{3}} - {P}_{{DS}_{4}} \\ {P}_{{DS}_{4}}\end{matrix}\end{matrix} & ( i = 1 , 2 , 3 , 4 )\end{matrix} , \qquad ( 12 )$$

where

$${P}_{f}^{( i )}$$

represents a damage exceedance probability function; P_{DS1}, P_{DS2}, P_{DS3}, and P_{DS4} correspond to the exceedance probabilities of the slight damage, moderate damage, severe damage, and the complete damage, respectively;
step 3.5, under a given ground motion intensity, when Q_{L} exceeds the threshold Lᵢ (i=1, 2, 3) corresponding to a damage state, the damage state corresponding to the threshold is considered reached; in particular, for a conservative estimate of the complete damage state, it is determined that the complete damage state is reached when Q_{L} exceeds 0.85 L₄.

Further, the step 4 includes:
step 4.1, the post-earthquake bridge residual traffic functionality Qᵣ is calculated,

$${Q}_{r} = 1 - {Q}_{L} ; \qquad ( 13 )$$

step 4.2, the post-earthquake repair time Tᵣₑⱼ for the bearings, the piers, and the tracks is calculated,

$${T}_{r e j} = {\sum }_{i = 1}^{4} {P}_{f}^{( i )} {T}_{i} ( j = 1 , 2 , 3 ) , \qquad ( 14 )$$

where

$${P}_{f}^{( i )}$$

represents a damage exceedance probability function, and Tᵢ is a repair time required for the key bridge component to reach an i-th damage state;
step 4.3, traffic functionality values Qᵣ₁, Qᵣ₂, and Qᵣ₃ after full recovery of the piers, the bearings, and the tracks are calculated,

$${Q}_{r 1} = {Q}_{r} + 0.7 {Q}_{L} , \qquad ( 15 )$$

$${Q}_{r 2} = {Q}_{r} + ( 0.7 + 0 \text{.2} ) {Q}_{L} , \qquad ( 16 )$$

$${Q}_{r 3} = {Q}_{r} + ( 0.7 + 0.2 + 0 \text{.1} ) QL = 1 ; \qquad ( 17 )$$

step 4.4, the post-earthquake traffic functionality recovery curve of the bridge is established,

$$Q ( t ) = \{ \begin{matrix}{Q}_{r} \\ {Q}_{r 1} \\ {Q}_{r 2} \\ 1\end{matrix} = \{ \begin{matrix}{Q}_{r} & {t}_{0} \leq t < {t}_{1} \\ {Q}_{r} + 0.7 {Q}_{L} & {t}_{1} \leq t < {t}_{2} \\ {Q}_{r} + ( 0.7 + 0.2 ) {Q}_{L} & {t}_{2} \leq t < {t}_{3} \\ 1 & {t}_{3} \leq t\end{matrix} , \qquad ( 18 )$$

where Q(t) is a function recovery function; t represents a post-earthquake time; t₀ is a repair start time; t₁ is a repair completion time of a first type of components; t₂ is a repair completion time of a second type of components; and t₃ is a repair completion time of a third type of components.

Further, the step 5 includes:
step 5.1, the seismic resilience index R of the bridge is calculated,

$${T}_{r e} = {\sum }_{j = 1}^{3} {T}_{rej} , \qquad ( 19 )$$

$$R = \frac{1}{{T}_{re}} {\int }_{{t}_{0}}^{{t}_{0} + {T}_{re}} Q ( t ) dt , \qquad ( 20 )$$

where Tᵣₑ is a total post-earthquake repair time;
step 5.2, on a basis of a bearing damage evolution curve, a pier damage evolution curve, and a traffic functionality damage evolution curve, the ground motion intensities corresponding to an 85% damage rate for the bearings and the piers are calculated as the minimum ground motion intensities for structural safety, denoted as PGA_{b4} and PGAₚ₄;
step 5.3, on a basis of the bearing damage evolution curve, the pier damage evolution curve, and the traffic functionality damage evolution curve, the ground motion intensities corresponding to a traffic functionality loss rate reaching the slight damage and an 85% damage rate are calculated as traffic safety thresholds, denoted as PGAₜ₁ and PGAₜ₄, respectively;
step 5.4, on a basis of the ground motion intensity-seismic resilience index curve, the resilience indices R₁, R₂, and R₃ corresponding to PGA₁₁, PGA₄, and min(PGA_{b4}, PGAₚ₄) are calculated, respectively. In this way, three seismic resilience levels are defined, and the seismic resilience index thresholds corresponding to the three seismic resilience levels are determined.

A seismic resilience assessment system for a railway girder bridge includes a simulation module, a model construction module, a loss evolution analysis module, a functionality recovery analysis module, and an assessment module,
the simulation module is configured to: establish a nonlinear finite element model of an entire bridge to simulate and output seismic responses of key bridge components; and calculate, on a basis of the seismic responses of the key bridge components and a beam-track deformation mapping relationship, track alignment irregularity V, where the key bridge components include piers, bearings, and tracks;
the model construction module is configured to: establish, on a basis of pier analysis results under seismic waves, a logarithmic scatter plot between ground motion intensity and pier curvature ductility factor; establish, on a basis of bearing analysis results under the seismic waves, a logarithmic scatter plot between the ground motion intensity and bearing displacement; establish, on a basis of track alignment irregularity analysis results under the seismic waves, a logarithmic scatter plot between the ground motion intensity and track alignment irregularity V; and perform linear regression on the three scatter plots above to establish probabilistic seismic demand models for responses of key bridge components;
the loss evolution analysis module is configured to: calculate damage exceedance probabilities of key bridge components; normalize, on a basis of capacity thresholds, damage rate thresholds L1ᵢ, L2ᵢ, and L3ᵢ of the key bridge components; calculate bearing damage rate Q_{LB}, pier damage rate Q_{LP}, and bridge traffic functionality loss Q_{L} by weighting the damage exceedance probabilities; and establish damage evolution curves of the key bridge components under varying ground motion intensities;
the functionality recovery analysis module is configured to: obtain, according to the traffic functionality loss Q_{L}, a post-earthquake bridge residual traffic functionality Qᵣ; calculate a post-earthquake component repair time Tᵣₑⱼ (j=1, 2, 3); calculate traffic function values Qᵣ₁, Qᵣ₂, and Qᵣ₃ after full recovery of each key bridge component; and finally establish, on a basis of the calculations above, post-earthquake bridge traffic functionality recovery curve;
the assessment module is configured to: obtain, on a basis of the damage evolution curves of the key bridge components and the post-earthquake bridge traffic functionality recovery curves under varying ground motion intensities, minimum ground motion intensities at which the bearings and the piers reach complete damage levels, and minimum ground motion intensities at which the tracks reach slight damage and the complete damage levels; and determine, on a basis of an ground motion intensity-seismic resilience index curve, boundary values of three seismic resilience levels of the bridge, i.e., normal passage, speed-restricted passage, and structural safety.

### BRIEF DESCRIPTION OF THE DRAWINGS

FIG. 1 is a finite element analysis model of a bridge according to an embodiment.

FIG. 2 is a constitutive model of a pier fiber material according to an embodiment.

FIG. 3 is a constitutive model of a bearing according to an embodiment.

FIG. 4 is a constitutive model of the interaction between a main girder, an abutment, and a stopper according to an embodiment.

FIG. 5 is a schematic diagram of a target response spectrum curve according to an embodiment.

FIG. 6 is a schematic diagram of response spectrum curves of 100 natural seismic waves according to an embodiment.

FIG. 7 is a schematic diagram of relative displacement at a main girder end under seismic response according to an embodiment.

FIG. 8 is a schematic diagram of bearing displacement under seismic response according to an embodiment.

FIG. 9 is curvature of the cross-section at the bottom of a pier under seismic response according to an embodiment.

FIG. 10 is a schematic diagram of track alignment irregularity according to an embodiment.

FIG. 11 is a schematic diagram of a cross-sectional strain-curvature curve according to an embodiment.

FIG. 12 is a logarithmic scatter plot and probabilistic seismic demand model plot of a curvature ductility factor for a 14 m pier according to an embodiment.

FIG. 13 is a logarithmic scatter plot and probabilistic seismic demand model plot of bearing displacement in a first span according to an embodiment.

FIG. 14 is a logarithmic scatter plot of ground motion intensity and track alignment irregularity according to an embodiment.

FIG. 15 is vulnerability curves of 14 m, 12 m, and 8 m piers according to an embodiment.

FIG. 16 is a vulnerability curve of a bearing in a first span according to an embodiment.

FIG. 17 is a vulnerability curve of traffic functionality at expansion joints of an abutment and a pier according to an embodiment.

FIG. 18 is a pier damage evolution curve according to an embodiment.

FIG. 19 is a bearing damage evolution curve according to an embodiment.

FIG. 20 is a traffic functionality damage evolution curve according to an embodiment.

FIG. 21 is a schematic diagram of a residual traffic functionality Qᵣ according to an embodiment.

FIG. 22 is a schematic diagram of post-earthquake repair time for bearings, piers, and tracks according to an embodiment.

FIG. 23 is a schematic diagram of a post-earthquake traffic functionality recovery curve according to an embodiment.

FIG. 24 is a schematic diagram of a seismic resilience index curve according to an embodiment.

FIG. 25 is a flowchart of a seismic resilience assessment method for a railway girder bridge according to an embodiment.

### DETAILED DESCRIPTION OF THE EMBODIMENTS

To make the objects, technical solutions, and advantages of embodiments of the present application clearer, the technical solutions in the embodiments of the present application are clearly and thoroughly described below with reference to the drawings in the embodiments of the present application. It is apparent that the described embodiments are merely part of the embodiments of the present application and not all of the embodiments. Accordingly, the following detailed description of embodiments of the present application provided in the drawings is merely illustrative of selected embodiments of the present application and is not intended to limit the scope of the present application as defined by the claims. All other embodiments obtained by those skilled in the art on a basis of the embodiments in the present application without creative work shall fall within the scope of protection of the present application.

To solve the problems in the prior art, the present disclosure provides a seismic resilience assessment method and system for a railway girder bridge, thereby solving the technical problem of the absence of seismic resilience assessment methods applicable to railway bridges in the prior art.

A seismic resilience assessment method for a railway girder bridge, as shown in FIG. 25, includes:
step 1, a nonlinear finite element model of an entire bridge is established to simulate and output seismic responses of key bridge components; track alignment irregularity V is calculated on a basis of the seismic responses of the key bridge components and a beam-track deformation mapping relationship, where the key bridge components include piers, bearings, and tracks;
step 2, a logarithmic scatter plot between ground motion intensity and pier curvature ductility factor is established on a basis of analysis results of piers under seismic waves; a logarithmic scatter plot between the ground motion intensity and bearing displacement is established on a basis of bearing analysis results under the seismic waves; a logarithmic scatter plot between the ground motion intensity and the track alignment irregularity V is established on a basis of track alignment irregularity analysis results under the seismic waves; linear regression is performed on the three scatter plots above to establish probabilistic seismic demand models for responses of the key bridge components;
step 3, damage exceedance probabilities of the key bridge components under different damage states are calculated on a basis of the probabilistic seismic demand models for responses of the key bridge components; damage rate thresholds of the key bridge components are normalized on a basis of capacity thresholds; a bearing damage rate Q_{LB}, a pier damage rate Q_{LP}, and a bridge traffic functionality loss Q_{L} are calculated by weighting the damage exceedance probabilities and the damage rate thresholds; damage evolution curves of the key bridge components under varying ground motion intensities are established;
step 4, a post-earthquake bridge residual traffic functionality Qᵣ is obtained according to the traffic functionality loss Q_{L}; a post-earthquake component repair time Tᵣₑⱼ (j=1, 2, 3) is calculated; traffic functionality values Qᵣ₁, Qᵣ₂, and Qᵣ₃ after full recovery of each key bridge component are calculated; finally, post-earthquake traffic functionality recovery curves are established;
step 5, a seismic resilience index of a bridge is calculated; minimum ground motion intensities at which the bearings and the piers reach complete damage levels and minimum ground motion intensities at which the tracks reach slight damage and the complete damage levels are obtained on a basis of the damage evolution curves of the key bridge components and the post-earthquake traffic functionality recovery curves under varying ground motion intensities; boundary values of three seismic resilience levels of the bridge are determined on a basis of an ground motion intensity-seismic resilience index curve, i.e., normal passage, speed-restricted passage, and structural safety.

In another embodiment, the step 1 includes the following steps.

At step 1.1, a nonlinear finite element model of the entire bridge is established according to bridge design parameters.

Considering the nonlinear mechanical characteristics of key components, the bearings are simulated using nonlinear elements, the piers are simulated using nonlinear beam-column elements, and the main girders are simulated using beam elements.

In this embodiment, the bridge spans are arranged as 32×5 m. The main girder is a ballastless double-track precast concrete box girder, with a width of 11.6 m and a height of 2.6 m, and is constructed of C50 concrete. The secondary dead load on the bridge deck is 120 kN/m. The expansion joint gaps at the piers and abutments are 10 cm and 20 cm, respectively, and the lateral clearance between the stopper and the main girder is 5 cm. Four spherical steel bearings are arranged on each span, with longitudinal sliding bearings on one side and fixed bearings on the other side. The piers, with heights of 8 m, 14 m, 12 m, 8 m, etc., are solid piers with circular end cross-sections. The piers are constructed of C35 concrete, longitudinally reinforced with HRB400 rebars of 25 mm diameter, and the stirrups are HRB400 rebars with a diameter of 12 mm.

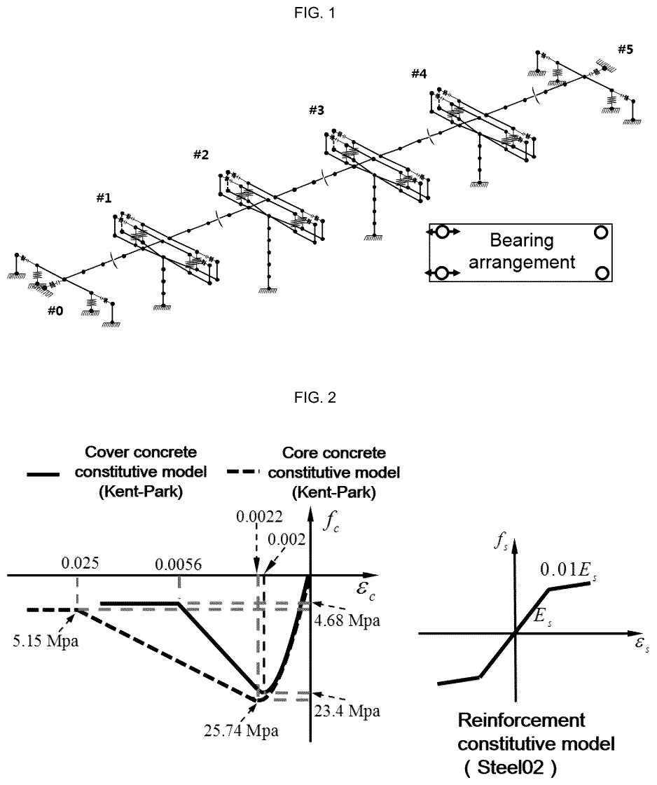

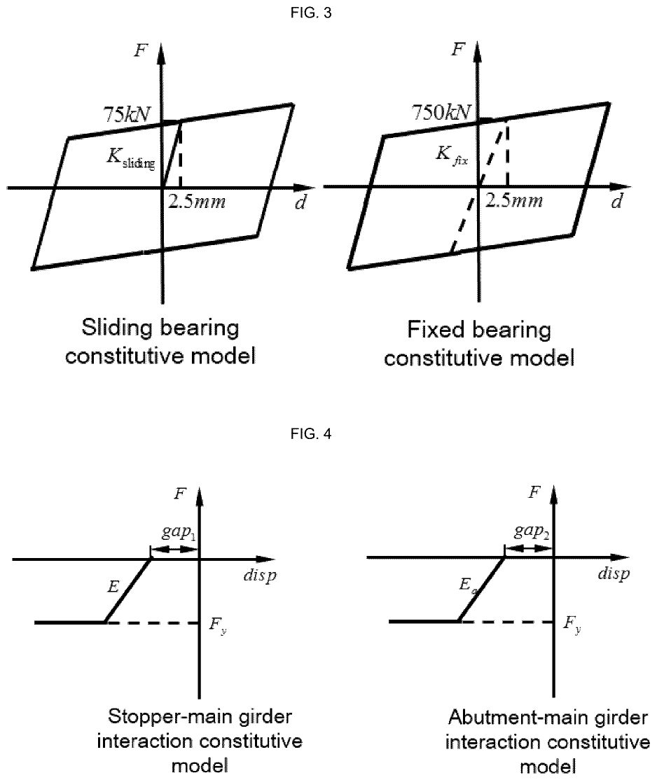

The bearings exhibit bilinear mechanical behavior under seismic action and are modeled using a bilinear constitutive model. The fixed bearing has a yield force of 750 kN, a yield displacement of 2.5 mm, and a post-yield stiffness coefficient of 0.001. The sliding bearing has a yield force of 75 kN, a yield displacement of 2.5 mm, and a post-yield stiffness coefficient of 0.001. The piers are simulated using nonlinear beam-column elements. The concrete is simulated using the Kent-Park constitutive model. The reinforcement is simulated using the Steel02 constitutive model. The main girder is simulated using an elastic beam-column element. The interaction between the main girder and both the stoppers and abutments is simulated using gap-type elastoplastic elements. Reference is made to FIGS. 1 to 4 for modeling information of the nonlinear finite element model. In FIG. 2, f_{c}, ε_{c}, fₛ, εₛ, and Eₛ are concrete stress, concrete strain, reinforcement stress, reinforcement strain, and modulus of elasticity of reinforcement, respectively. In FIG. 3, F and d are horizontal force and displacement of the bearing, respectively. In FIG. 4, f, Δ, gap₁, gap₂, f_{y1}, f_{y2}, E, and Eₐ are interaction force between the main girder and the stopper or abutment, deformation of the stopper or abutment, gap between the main girder and the stopper, gap between the main girder and the abutment, yield force of the stopper, yield force of the abutment, stiffness of the stopper, and stiffness of the abutment, respectively.

At step 1.2, a target response spectrum curve is determined according to site conditions of the bridge.

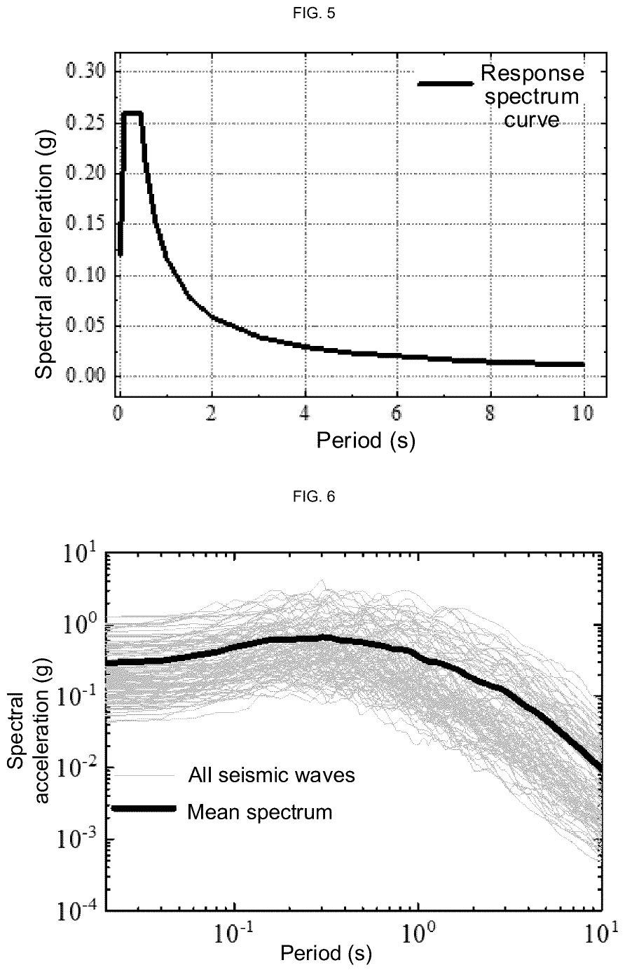

Referring to Section 5.2 of Specifications for Seismic Design of Highway Bridges (JTG/T 2231-01-2020), the target response spectrum curve is calculated, as shown in FIG. 5.

At step 1.3, on a basis of the target response spectrum curve, no fewer than 60 seismic waves are selected from the Pacific Earthquake Engineering Research (PEER) before inputting into the finite element model to perform nonlinear time-history analysis.

In this embodiment, 100 natural seismic waves are selected. The response spectrum curve of the seismic waves is shown in FIG. 6, and partial information of the seismic waves is listed in Table 1.

TABLE 1
Partial Information of Input Seismic waves

| | | | Seismic | | | | |
|---|---|---|---|---|---|---|---|
| | Earthquake | | Station | | Peak | | Time |
| No. | Name | Year | Name | Magnitude | Acceleration/g | Duration | Step/s |
| 68 | “San | 1971 | “LA- | 6.61 | 0.224 | 79.44 | 0.01 |
| | Fernando” | | Hollywood | | | | |
| | | | Stor FF” | | | | |
| 768 | “Loma | 1989 | “Gilroy | 6.93 | 0.419 | 39.985 | 0.005 |
| | Prieta” | | Array #4” | | | | |
| 993 | Northridge- | 1994 | “LA- | 6.69 | 0.172 | 29.98 | 0.01 |
| | 01” | | Fletcher | | | | |
| | | | Dr” | | | | |
| 1032 | Northridge- | 1994 | “Leona | 6.69 | 0.178 | 31.98 | 0.02 |
| | 01” | | Valley #6” | | | | |

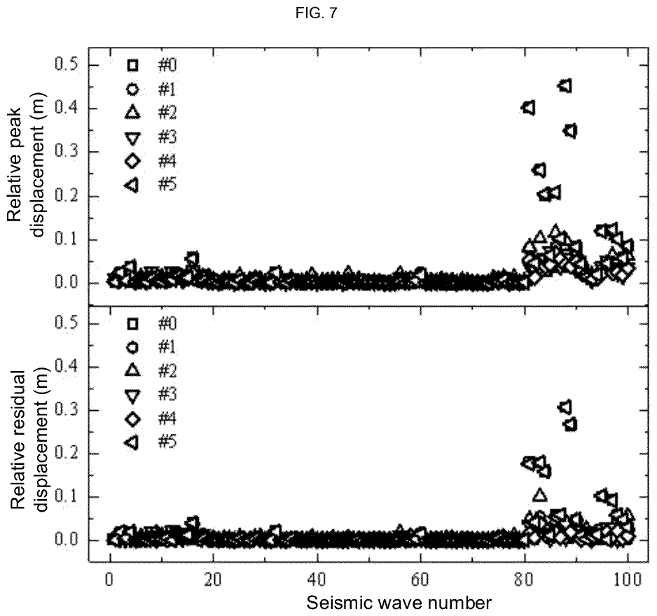

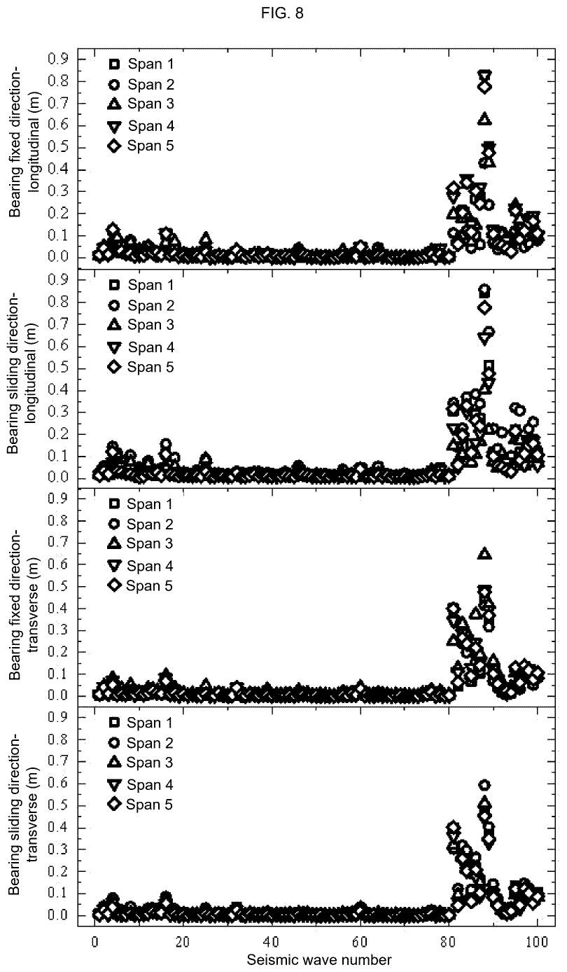

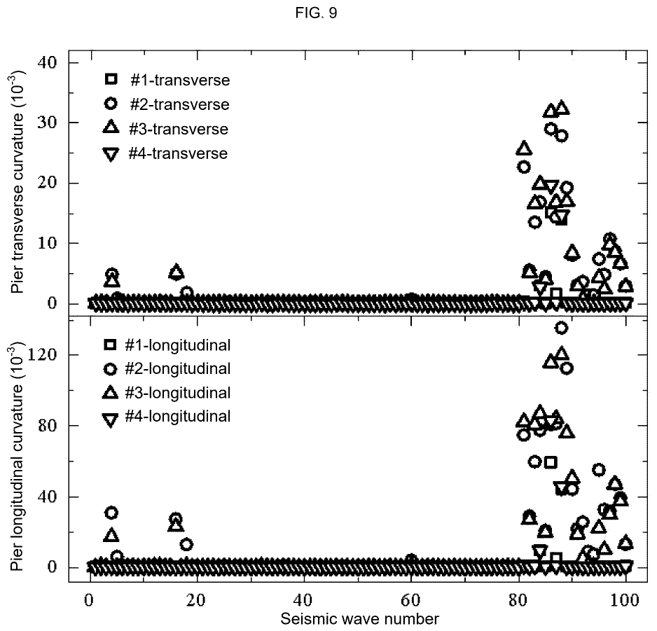

At step 1.4, relative displacement of a main girder end at an expansion joint, bearing deformation, and curvature 9o of the cross-section at the bottom of the pier are output as the seismic responses of the key bridge components, the relative displacement of the main girder end at the expansion joint including a peak displacement Dᵣ and a residual displacement Dₚ, as shown in FIG. 7, with a total of 600 sets of results. Since the bearings are divided into fixed-direction and sliding-direction types, and the horizontal yield force of the fixed-direction bearings is relatively high, resulting in different seismic performance compared to the sliding-direction bearings, the maximum displacements of the bearings of each span in the fixed direction and the sliding direction are output separately, as shown in FIG. 8, with a total of 500 sets of results. Additionally, the curvature of the cross-section at the bottom of four piers in the longitudinal and transverse directions of the bridge is recorded, as shown in FIG. 9, with a total of 400 sets of data.

At step 1.5, on a basis of the beam-track deformation mapping relationship, the results of the peak displacement Dᵣ and residual displacement Dₚ from FIG. 7 are substituted into Equation (1) to calculate the track alignment irregularity V.

In another embodiment, the track alignment irregularity V is calculated as follows:

$$V ( {D}_{p} , {D}_{r} ) = {g}_{4} ( {D}_{p} ) {D}_{r}^{4} + {g}_{3} ( {D}_{p} ) {D}_{r}^{3} + {g}_{2} ( {D}_{p} ) {D}_{r}^{2} + {g}_{1} ( {D}_{p} ) {D}_{r} + {g}_{0} ( {D}_{p} ) \{ \begin{matrix}{g}_{4} ( {D}_{p} ) = 1.946 \times 1 {0}^{- 7} \\ {g}_{3} ( {D}_{p} ) = - 2.091 \times 1 {0}^{- 7} {D}_{p} - 4.568 \times 1 {0}^{- 5} \\ {g}_{2} ( {D}_{p} ) = 2.247 \times 1 {0}^{- 8} {D}_{p}^{2} + 5.084 \times 1 {0}^{- 5} {D}_{p} + 0.002567 \\ {g}_{1} ( {D}_{p} ) = - 6.634 \times 1 {0}^{- 6} {D}_{p}^{2} - 0.002909 {D}_{p} + 0.5072 \\ {g}_{0} ( {D}_{p} ) = 1.234 \times 1 {0}^{- 4} {D}_{p}^{2} + 0.02334 {D}_{p} + 0.04164\end{matrix} , \qquad ( 1 )$$

where Dᵣ is the peak displacement, Dₚ is the residual displacement, and g₀ to g₄ are intermediate calculation parameters.

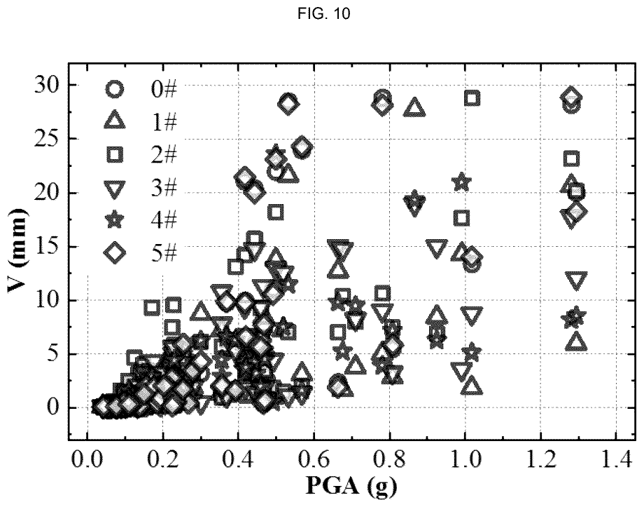

The peak displacement Dᵣ and residual displacement Dₚ of 100 seismic waves obtained from the nonlinear finite element model analysis are substituted into Equation (1) to calculate the track alignment irregularity, as shown in FIG. 10.

In another embodiment, the step 2 includes the following steps.

At step 2.1, cross-sectional analysis at the bottom of the pier is performed to establish a cross-sectional strain-curvature curve, and an initial yield curvature φ₀ corresponding to yielding of longitudinal reinforcement of the pier is obtained.

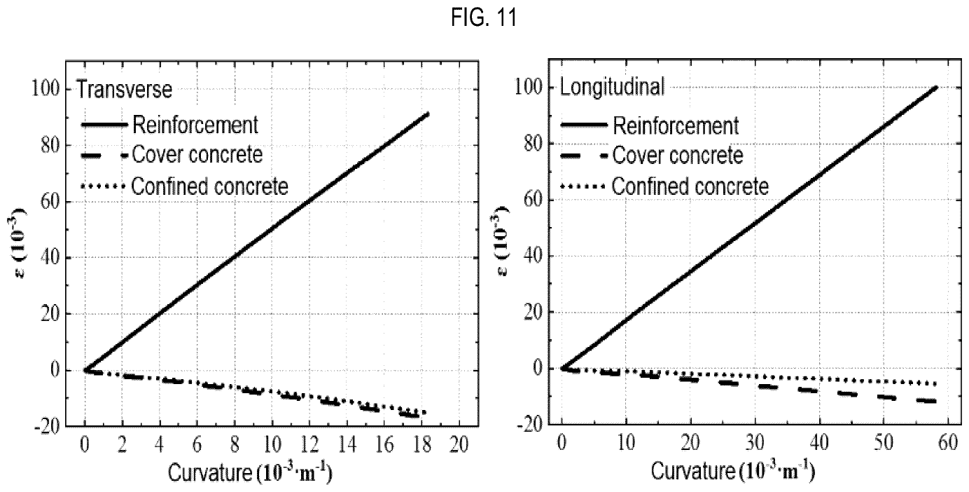

In this embodiment, the pier bottom section is established according to pushover analysis. A vertical load is applied to perform cross-sectional analysis at the bottom of the pier, resulting in the cross-sectional strain-curvature curve. An initial yield curvature φ₀ corresponding to the first yield of the longitudinal reinforcement of the pier is obtained. The longitudinal and transverse initial yield curvatures are 1.36 E-03 and 4.48 E-04, respectively, as shown in FIG. 11, where the ordinate E is the strain, which is a dimensionless variable.

At step 2.2, a curvature ductility factor pc of the pier is calculated according to the curvature 9p of the cross-section at the bottom of the pier under seismic action, as shown in Equation (2),

$${μ}_{c} = \frac{φ}{{φ}_{0}} . \qquad ( 2 )$$

At step 2.3, logarithms of peak ground acceleration of each ground motion, the bearing deformation of the model under the ground motion, the curvature ductility factor of the pier, and the track alignment irregularity V are taken, and a logarithmic scatter plot between ground motion intensity (e.g., peak ground acceleration (PGA)) and a seismic response (e.g., engineering demand parameter (EDP)) is established.

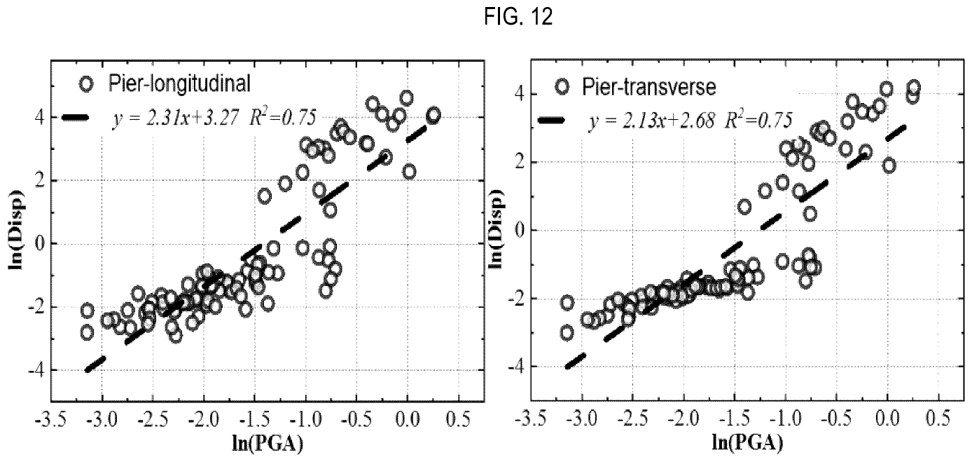

The maximum curvature ductility factor at the bottom of the piers #1 to #4 under each seismicwave input is taken as the seismic response (i.e., EDP) value of the piers. A logarithmic scatter plot between ground motion intensity (e.g., PGA) and pier curvature ductility factor is established on a basis of analysis results of piers under 100 seismic waves, as shown in FIG. 12. In particular, Disp in FIG. 12 represents the pier curvature ductility factor μ_{c}.

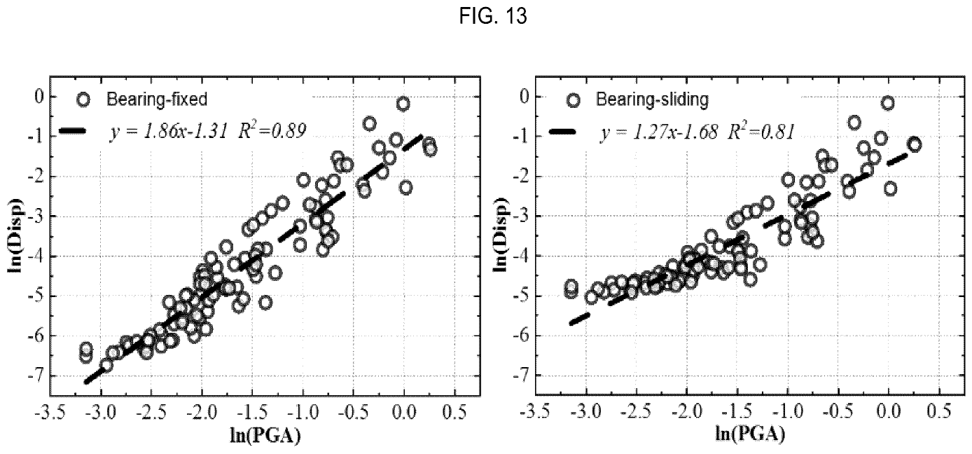

A logarithmic scatter plot between ground motion intensity (e.g., PGA) and bearing displacement is established on a basis of bearing analysis results of under 100 seismic waves. Due to the large number of bearings, only the results for the bearings in the first span are shown, as shown in FIG. 13. In particular, Disp in FIG. 13 represents the displacement of the bearings in the first span.

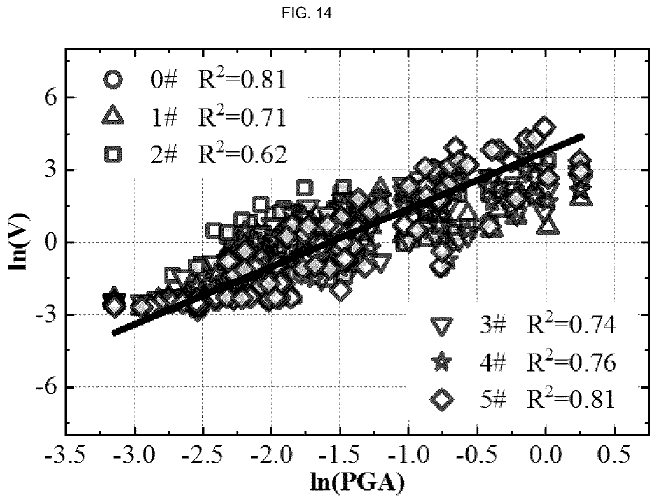

A logarithmic scatter plot between ground motion intensity (e.g., PGA) and track alignment irregularity V is established on a basis of track alignment irregularity analysis results under 100 seismic waves, as shown in FIG. 14.

At step 2.4, linear regression is performed on the logarithmic scatter cloud plot to establish probabilistic seismic demand models for bearings, piers, and track responses, as shown in Equation (3),

$$ln ( EDP ) = ln ( a ) + b ln ( IM ) , \qquad ( 3 )$$

where EDP is the seismic response, a and b are the regression parameters of the probabilistic seismic demand model, and IM is the ground motion intensity, which can be peak ground acceleration (PGA), peak ground velocity (PGV), or spectral acceleration (Sa). In this embodiment, PGA is used as the ground motion intensity.

In this embodiment, the regression model parameters for five-span bearings, four piers, and six beam joint tracks are shown in Table 2.

TABLE 2
Parameters of Probabilistic Seismic Demand Model

| Component | Bearing | | | Pier | | | Track | |
|---|---|---|---|---|---|---|---|---|
| Parameter | a | b | | a | b | | a | b |
| Bridge span | 1.86 | 1.31 | #1- | 1.02 | −0.55 | #0 | 2.29 | 3.53 |
| 1-Fixed | | | Transverse | | | | | |
| Bridge span | 1.27 | 1.68 | #1- | 0.96 | −0.20 | #1 | 1.64 | 2.51 |
| 2-Fixed | | | Longitudinal | | | | | |
| Bridge span | 1.71 | 1.85 | #2- | 2.13 | 2.68 | #2 | 1.59 | 2.89 |
| 3-Fixed | | | Transverse | | | | | |
| Bridge span | 1.15 | 1.38 | #2- | 2.31 | 3.27 | #3 | 1.73 | 2.80 |
| 4-Fixed | | | Longitudinal | | | | | |
| Bridge span | 1.83 | 1.35 | #3- | 2.12 | 2.30 | #4 | 1.71 | 2.70 |
| 5-Fixed | | | Transverse | | | | | |
| Bridge span | 1.05 | 2.08 | #3- | 2.21 | 2.85 | #5 | 2.33 | 3.53 |
| 1-Sliding | | | Longitudinal | | | | | |
| Bridge span | 1.80 | 1.31 | #4- | 0.98 | −0.66 | | | |
| 2-Sliding | | | Transverse | | | | | |
| Bridge span | 1.06 | 1.93 | #4- | 0.95 | −0.22 | | | |
| 3-Sliding | | | Longitudinal | | | | | |
| Bridge span | 1.71 | 1.58 | | | | | | |
| 4-Sliding | | | | | | | | |
| Bridge span | 1.26 | 1.92 | | | | | | |
| 5-Sliding | | | | | | | | |

In another embodiment, the step 3 includes the following steps.

At step 3.1, the damage states of the key bridge components are divided into five levels, including no damage, slight damage, moderate damage, severe damage, and complete damage, and the corresponding control indicators are determined, where the control indicator for the piers includes longitudinal reinforcement strain and concrete strain, the control indicator for the bearings includes bearing displacement, and the control indicator for the tracks includes track alignment irregularity.

In particular, the indicators are as follows:

TABLE 3
Damage Criteria and Control Indicators for Piers

| | Damage State | | |
|---|---|---|---|
| Damage State | Description | Indicator Control | Indicator Threshold |
| No Damage | No structural | Longitudinal | μ_{c} < μ₁ |
| | damage; only minor | reinforcement strain | |
| | cracks on concrete | εₛ < yield strain | |
| | surface | (0.002) | |
| Slight Damage | Visible cracks on | Longitudinal | μ₁ ≤ μ_{c} < μ₂ |
| | concrete surface but | reinforcement strain | |
| | few in number; no | εₛ ≥ yield strain | |
| | spalling of cover | (0.002) | |
| | layer | | |
| Moderate Damage | Significantly | Cover concrete | μ₂ ≤ μ_{c} < μ₃ |
| | increased cracks | compressive strain | |
| | with greater depth | ε_{c} = 0.004 | |
| | on concrete surface; | | |
| | local concrete | | |
| | spalling | | |
| Severe Damage | Wide cracks on | Longitudinal | μ₃ ≤ μ_{c} < μ₄ |
| | concrete surface; | reinforcement strain | |
| | extensive spalling; | reaches 0.55 times | |
| | stirrups exposed; | ultimate tensile | |
| | longitudinal bars | strain; confined | |
| | clearly visible | concrete reaches | |
| | | 0.75 times ultimate | |
| | | compressive strain | |
| Complete Damage | Tensile longitudinal | Core concrete | μ₄ ≤ μ_{c} |
| | bars fractured or | reaches ultimate | |
| | compressive | compressive strain, | |
| | longitudinal bars | or longitudinal | |
| | buckled; core | reinforcement | |
| | concrete crushed; | reaches ultimate | |
| | pier column damage | tensile strain | |

Note: εₛ is the longitudinal reinforcement strain; ε_{c} is the concrete strain; and μ₁, μ₂, μ₃, and μ₄ are the ductility factor thresholds corresponding to slight damage, moderate damage, severe damage and complete damage of the piers.

TABLE 4
Damage Criteria and Control Indicators for Bearings

| Damage State | Damage State Description | Indicator Control |
|---|---|---|
| No Damage | Stopper plate or shear resisting apparatus intact | d < D₀ |
| Slight Damage | Stopper plate or shear resisting apparatus | D₀ ≤ d < D_{c} |
| | damaged; horizontal seismic displacement | |
| | exceeds normal bearing displacement | |
| Moderate | Large horizontal seismic displacement; stopper | D_{c} ≤ d < 2D_{c} |
| Damage | plate or shear resisting apparatus damaged in | |
| | limiting direction; small residual displacement after | |
| | earthquake | |
| Severe | Large horizontal seismic displacement; stopper | 2D_{c} ≤ d < 3.3D_{c} |
| Damage | plate or shear resisting apparatus damaged in the | |
| | limiting direction; friction slider damaged but upper | |
| | plate not detached; large residual displacement | |
| | after earthquake | |
| Complete | Large horizontal seismic displacement; upper plate | 3.3D_{c} ≤ d |
| Damage | completely slipped off the stainless steel plate, in a | |
| | sliding-off state | |

Note: d is the bearing displacement; Do is the allowable normal displacement of the bearing; and D_{c} is the allowable seismic displacement of the bearing.

TABLE 5
Damage Criteria and Control Indicators for Tracks

| Damage State | Damage State Description | Indicator Control |
|---|---|---|
| No Damage | Traffic permitted at a design speed | V < 9 mm |
| | of 200 km/h | |
| Slight Damage | Traffic speed reduced to 160 km/h | 9 mm ≤ V < 12 mm |
| Moderate Damage | Traffic speed reduced to 120 km/h | 12 mm ≤ V < 15 mm |
| Severe Damage | Traffic speed reduced to 80 km/h | 15 mm ≤ V < 18 mm |
| Complete Damage | Traffic speed reduced to below 45 | 18 mm ≤ V |
| | km/h | |

Refer to the Code for Seismic Design of Railway Engineering (GB 50111-2006, 2009 edition), the thresholds for track irregularity indices are listed in Table 6.

In this embodiment, the allowable normal displacements D₀ of the bearing are 60 mm in the sliding direction and 3 mm in the fixed direction, while the allowable seismic displacement of the bearing D_{c} is 150 mm. Referring to the bearing damage classification criteria, the damage thresholds for the bearings are listed in Table 6.

According to the cross-sectional strain-curvature curve in FIG. 6 and referring to the pier damage classification criteria, the curvature ductility factor thresholds corresponding to various damage states of the pier are listed in Table 6.

TABLE 6
Damage Criteria and thresholds for Bearings, Piers, and Tracks

| | Damage State | | | | |
|---|---|---|---|---|---|
| | No | Slight | Moderate | Severe | Complete |
| Component | Damage | Damage | Damage | Damage | Damage |
| Bearing-Fixed | d < 2 mm | 2 mm ≤ | D_{c}≤ d | 2D_{c} ≤ | 3.3D_{c} ≤ d |
| Direction | | d < D_{c} | < 2D_{c} | d < 3.3D_{c} | |
| Bearing-Sliding | d < 60 mm | 60 mm ≤ | D_{c} ≤ | 2D_{c} ≤ | 3.3D_{c} ≤ d |
| Direction | | d < D_{c} | d < 2D_{c} | d < 3.3D_{c} | |
| Pier-Transverse | μ_{c} < 1.0 | 1.0 ≤ | 12.47 ≤ | 24.05 ≤ | 43.80 ≤ μ_{c} |
| | | μ_{c} < 12 | μ_{c} < 24.05 | μ_{c} < 43.80 | |
| Pier-Longitudinal | μ_{c} < 1.0 | 1.0 ≤ | 12.47 ≤ | 24.05 ≤ | 42.12 ≤ μ_{c} |
| | | μ_{c} < 12 | μ_{c} < 24.05 | μ_{c} < 42.12 | |
| Track | V < 9 mm | 9 mm ≤ | 12 mm ≤ | 15 mm ≤ | 18 mm ≤ V |
| | | V < 12 mm | V < 15 mm | V < 18 mm | |

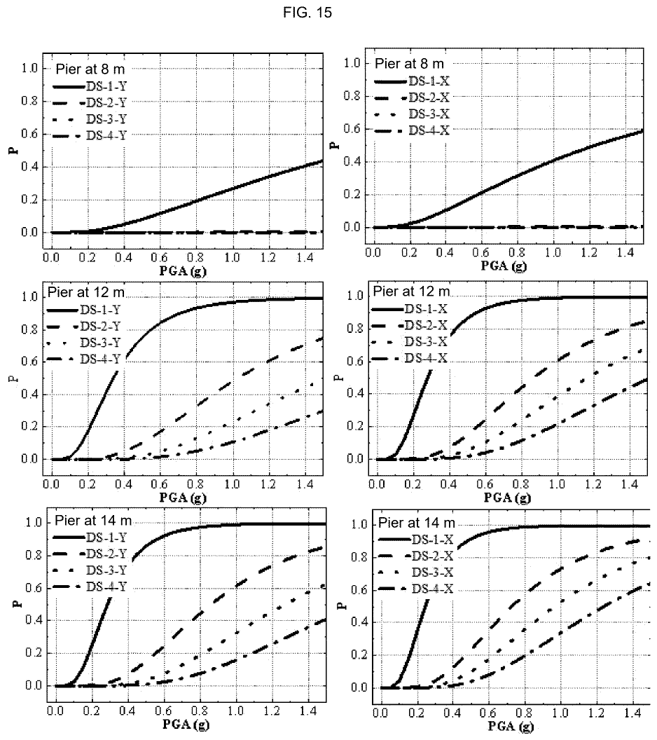

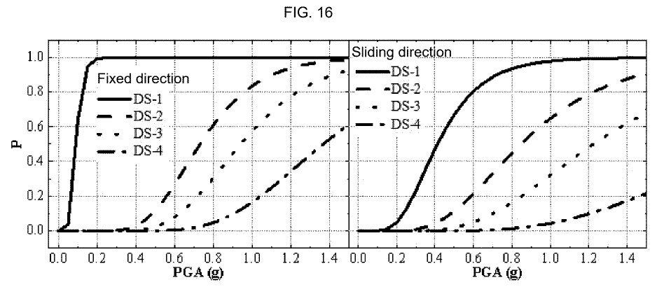

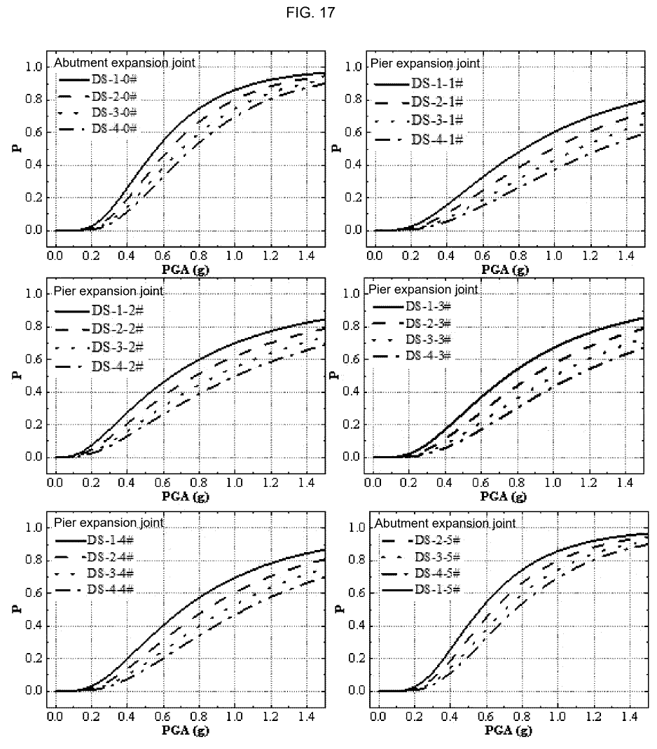

At step 3.2, vulnerability is defined as the exceedance probability P that the structural response exceeds the seismic capacity under a given ground motion intensity, which can be calculated using Equations (4) and (5). The mean seismic capacity S_{c} of structural components is taken from Table 3, and the logarithmic standard deviation of seismic capacity of the components is generally assumed to be 0.5. The seismic response (EDP) includes bearing displacement, pier curvature ductility factor, and track alignment irregularity. The number of seismic waves N is 100. The calculated vulnerability results under different ground motion intensities are shown in FIGS. 15 to 17. FIG. 15 shows vulnerability curves for piers of varying heights. FIG. 17 shows vulnerability curves of traffic functionality corresponding to different beam joints, categorized into two groups: abutments and pier expansion joints, numbered sequentially as #0, #1, #2, #3, #4, and #5.

$$P = P ( EDP > {S}_{c} \vert IM ) = Φ ( \frac{ln ( EDP ) - ln ( {S}_{c} )}{\sqrt{{β}_{c}^{2} + {β}_{d}^{2}}} ) , \qquad ( 4 )$$

$${β}_{d} = \sqrt{\frac{{\sum }_{i = 1}^{N} {[ ln ( {EDP}_{i} ) - ( ln a + b \cdot ln ( IM ) ) ]}^{2}}{N - 2}} , \qquad ( 5 )$$

where P includes P_{DS1}, P_{DS2}, P_{DS3}, and P_{DS4}, corresponding to five damage states and four associated thresholds, which represent the damage exceedance probabilities. S_{c} is the mean seismic capacity of the structural component; β_{c} is the logarithmic standard deviation of the seismic capacity of the component; β_{d} is the logarithmic standard deviation of the seismic response of the component; EDP is the seismic response; EDPᵢ is the seismic response under the action of an i-th seismic wave (where i=1 to 100); and N is the number of input seismic waves.

In another embodiment, step 3 further includes:

At step 3.3, the damage rate thresholds L1ᵢ, L2ᵢ, and L3ᵢ are calculated for each key bridge component at the i-th damage state, where Equations (6) to (8) correspond to bearings, piers, and tracks, respectively,

$$L {1}_{i} = \frac{{D}_{i}}{3.3 {D}_{c}} ( i = 1 , 2 , 3 , 4 ) , \qquad ( 6 )$$

$$L {2}_{i} = \frac{{μ}_{i}}{{μ}_{4}} ( i = 1 , 2 , 3 , 4 ) , \qquad ( 7 )$$

$$L {3}_{i} = \frac{{V}_{d \_ max} - {V}_{r}}{{V}_{d \_ max} - {V}_{min}} ( i = 1 , 2 , 3 , 4 ) , \qquad ( 8 )$$

where D_{c} is the allowable seismic displacement of the bearing; Dᵢ is the bearing deformation threshold for the i-th damage state of the bearing; Dᵢ (i=1, 2, 3, 4) corresponds to D₀, D_{c}, 2D_{c}, and 3.3D_{c}; and μᵢ is the sectional curvature ductility factor of the pier at the i-th damage state. V_{d_max} is the maximum design speed of the railway line (set to 200 km/h for conventional railways in this patent), and Vₘᵢₙ is the minimum design speed of the railway line (set to 45 km/h); and Vᵣ is the post-earthquake residual traffic speed.

During the specific implementation, Equation (6) includes:

Fixed bearing:

$$L {1}_{i} = \frac{{D}_{i}}{3.3 {D}_{c}} = \{ \begin{matrix}3 / ( 3.3 \times 150 ) & & 12.5 \% & i = 1 \\ 150 / ( 3.3 \times 150 ) & = & 31.3 \% & i = 2 \\ ( 2 \times 150 ) / ( 3.3 \times 150 ) & & 50. \% & i = 3 \\ ( 3 \times 150 ) / ( 3.3 \times 150 ) & & 100 \% & i = 4\end{matrix} , \qquad ( 6.1 )$$

Sliding bearing:

$$L {1}_{i} = \frac{{D}_{i}}{3.3 {D}_{c}} = \{ \begin{matrix}60 / ( 3.3 \times 150 ) & & 0.6 \% & i = 1 \\ 150 / ( 3.3 \times 150 ) & = & 31.3 \% & i = 2 \\ ( 2 \times 150 ) / ( 3.3 \times 150 ) & & 50. \% & i = 3 \\ ( 3 \times 150 ) / ( 3.3 \times 150 ) & & 100 \% & i = 4\end{matrix} . \qquad ( 6.2 )$$

Equation (7) includes:

Pier longitudinal:

$$L {2}_{i} = \frac{{μ}_{i}}{{μ}_{4}} = \{ \begin{matrix}1 / 43.8 & & 2.3 \% & i = 1 \\ 12.47 / 43.8 & = & 28.5 \% & i = 2 \\ 24.05 / 43.8 & & 54.9 \% & i = 3 \\ 43.8 / 43.8 & & 100 \% & i = 4\end{matrix} , \qquad ( 7.1 )$$

Pier transverse:

$$L {2}_{i} = \frac{{μ}_{i}}{{μ}_{4}} = \{ \begin{matrix}1 / 42.12 & & 2.4 \% & i = 1 \\ 12.47 / 42.12 & = & 25. \% & i = 2 \\ 24.05 / 42.12 & & 57.3 \% & i = 3 \\ 42.12 / 42.12 & & 100 \% & i = 4\end{matrix} . \qquad ( 7.2 )$$

Equation (8) is:

Track:

$$L {3}_{i} = \frac{{V}_{d \_ max} - {V}_{r}}{{V}_{d \_ max} - {V}_{min}} = \{ \begin{matrix}( 200 - 160 ) / ( 200 - 45 ) = 25.8 \% & i = 1 \\ ( 200 - 120 ) / ( 200 - 45 ) = 51.6 \% & i = 2 \\ ( 200 - 80 ) / ( 200 - 45 ) = 77.4 \% & i = 3 \\ ( 200 - 45 ) / ( 200 - 45 ) = 100 \% & i = 4\end{matrix} . \qquad ( 8 )$$

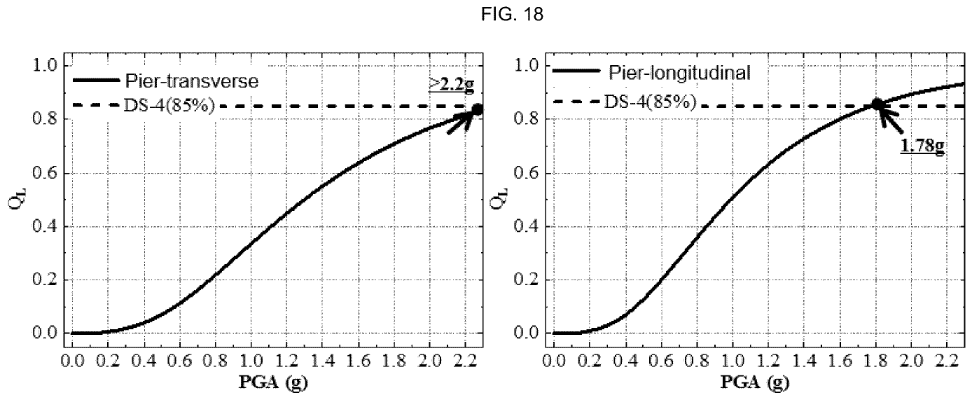

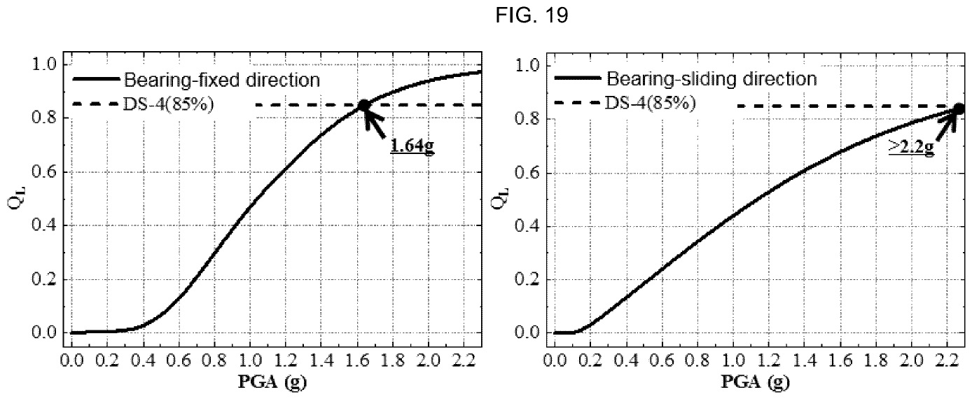

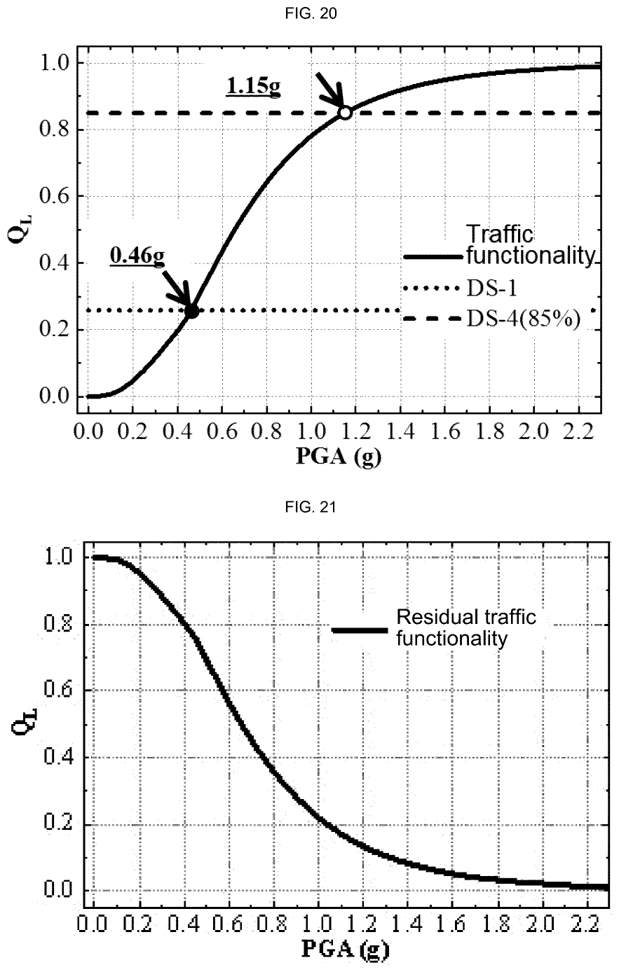

At step 3.4, on a basis of the vulnerability analysis results, bearing damage rate Q_{LB}, pier damage rate Q_{LP}, and bridge traffic functionality loss Q_{L} are calculated by weighting the damage exceedance probabilities and the damage rate thresholds, with reference to Equations (9) to (12). The damage evolution curves for bearings, piers, and traffic functionality (track) under varying ground motion intensities are shown in FIGS. 18 to 20. In the drawings, DS-1 corresponds to slight damage, DS-2 to moderate damage, DS-3 to severe damage, and DS-4 to complete damage,

$${Q}_{LB} = {\sum }_{i = 1}^{N} {P}_{f}^{( i )} L {1}_{i} ( i = 1 , 2 , 3 , 4 ) , \qquad ( 9 )$$

$${Q}_{LP} = {\sum }_{i = 1}^{N} {P}_{f}^{( i )} L {2}_{i} ( i = 1 , 2 , 3 , 4 ) , \qquad ( 10 )$$

$$QL = {\sum }_{i = 1}^{N} {P}_{f}^{( i )} L {3}_{i} ( i = 1 , 2 , 3 , 4 ) , \qquad ( 11 )$$

$${P}_{f}^{( i )} = \{ \begin{matrix}{P}_{{DS}_{1}} - {P}_{{DS}_{2}} \\ {P}_{{DS}_{2}} - {P}_{{DS}_{3}} \\ {P}_{{DS}_{3}} - {P}_{{DS}_{4}} \\ {P}_{{DS}_{4}}\end{matrix} ( i = 1 , 2 , 3 , 4 ) , \qquad ( 12 )$$

where

$${P}_{f}^{( i )}$$

represent the damage exceedance probability function P_{DS1}, P_{DS2}, P_{DS3}, and P_{DS4} correspond to the exceedance probabilities of slight damage, moderate damage, severe damage, and complete damage, respectively.

At step 3.5, under a given ground motion intensity, the bearings, piers, and traffic functionality are considered to have reached the corresponding damage state once their values exceed the thresholds for that damage state.

In another embodiment, the step 4 includes the following steps.

At step 4.1, when the ground motion intensity PGA=0.4 g, the post-earthquake bridge residual traffic functionality Qᵣ is calculated according to Equation (13). The residual functionality Qᵣ calculation results under other ground motion intensities are shown in FIG. 21,

$${Q}_{r} = 1 - {Q}_{L} = 1 - 0.20 = 0.80 . \qquad ( 13 )$$

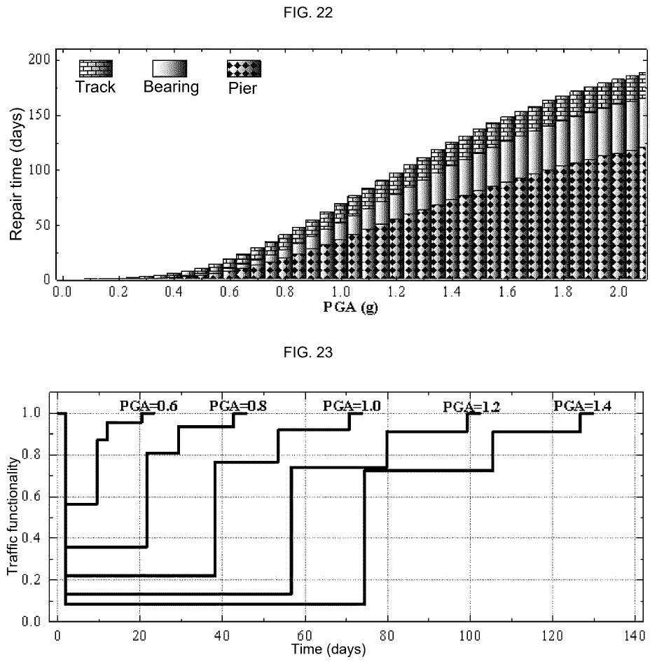

At step 4.2, when the ground motion intensity PGA=0.4 g, the post-earthquake repair time Tᵣₑⱼ (j=1, 2, 3) for bearings, piers, and tracks is calculated according to Equation (14). The repair time results of components under other ground motion intensities are shown in FIG. 22,

$${T}_{rej} = {\sum }_{i = 1}^{4} {P}_{f}^{( i )} {T}_{i} = \{ \begin{matrix}0.47 & ( j = 1 ) \\ 0.15 & ( j = 2 ) \\ 1.85 & ( j = 4 )\end{matrix} , \qquad ( 14 )$$

where

$${P}_{f}^{( i )}$$

represents the damage exceedance probability function, and Tᵢ is the repair time required for the component to reach an i-th damage state.

At step 4.3, post-earthquake repairs of bridge components generally proceed in the order of piers, bearings, and tracks. Upon completion of repairs for each component type, the bridge traffic functionality is restored according to a step function. The contributions of pier, bearing, and track recovery to the traffic functionality recovery are 0.7, 0.2, and 0.1, respectively. When the ground motion intensity PGA=0.4 g, the fully restored traffic functionality values of the piers, bearings, and tracks, denoted as Qᵣ₁, Qᵣ₂, and Qᵣ₃, can be calculated using Equations (15) to (17). The restoration values of bridge traffic functionality under other ground motion intensities can be calculated using the same method,

$${Q}_{r 1} = {Q}_{r} + 0.7 {Q}_{L} = 0.80 + 0.7 \times 0.20 = 0 \text{.94} , \qquad ( 15 )$$

$${Q}_{r 2} = {Q}_{r} + ( 0.7 + 0.2 ) {Q}_{L} = 0.8 + ( 0.7 + 0.2 ) \times 0.2 = 0.98 , \qquad ( 16 )$$

$${Q}_{r 3} = {Q}_{r} + ( 0.7 + 0.2 + 0.1 ) {Q}_{L} = 0.8 + ( 0.7 + 0.2 + 0.1 ) \times 0.2 = 1 \text{.00} . \qquad ( 17 )$$

At step 4.4, when the ground motion intensity PGA=0.3 g, the recovery curve function of bridge traffic functionality is shown in Equation (18), and the recovery curves of bridge traffic functionality under other ground motion intensities are shown in FIG. 23,

$$Q ( t ) = \{ \begin{matrix}{Q}_{r} \\ {Q}_{r 1} \\ {Q}_{r 2} \\ 1\end{matrix} = \{ \begin{matrix}{Q}_{r} & {t}_{0} \leq t < {t}_{1} \\ {Q}_{r} + 0.7 {Q}_{L} & {t}_{1} \leq t < {t}_{2} \\ {Q}_{r} + ( 0.7 + 0.2 ) {Q}_{L} & {t}_{2} \leq t < {t}_{3} \\ 1 & {t}_{3} \leq t\end{matrix} = \{ \begin{matrix}0.8 & 2 \leq t < 3.27 \\ 0.94 & 3.47 \leq t < 3.84 \\ 0.98 & 3.84 \leq t < 7.23 \\ 1. & 7.23 \leq t\end{matrix} , \qquad ( 18 )$$

where Q(t) is the function recovery function; t represents the post-earthquake time; t₀ is the repair start time; t₁ is the repair completion time of the first type of components (bearings or piers); t₂ is the repair completion time of the second type of components (bearings or piers); and t₃ is the repair completion time of the third type of components (tracks).

In another embodiment, the step 5 includes the following steps.

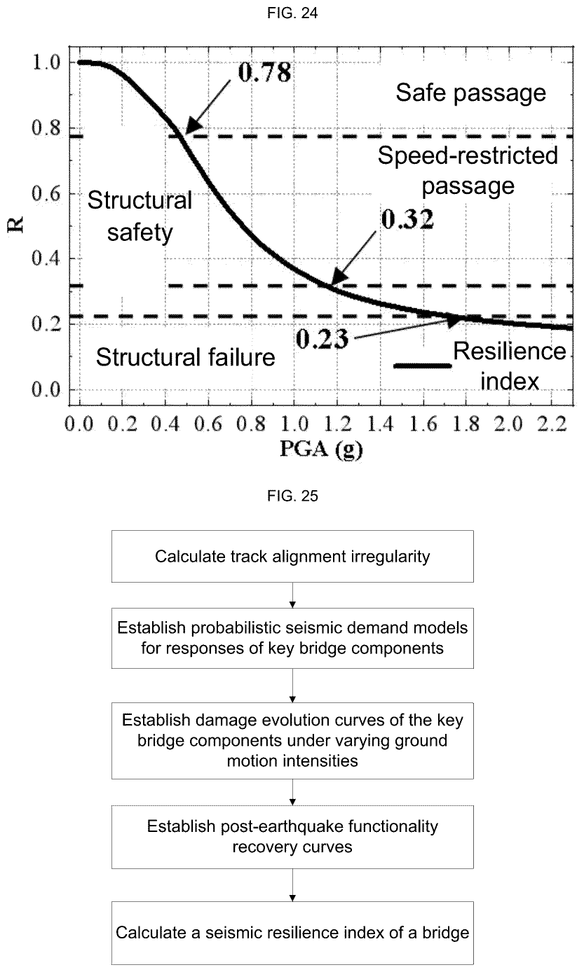

At step 5.1, when the ground motion intensity PGA=0.4 g, the seismic resilience index R of the bridge is calculated to be 0.83 according to Equations (19) and (20), and the seismic resilience index values of the bridge under other ground motion intensities are shown in FIG. 24,

$${T}_{r e} = {\sum }_{j = 1}^{3} {T}_{r e j} = 5.23 , \qquad ( 19 )$$

$$R = \frac{1}{{T}_{re}} {\int }_{{t}_{0}}^{{t}_{0} + {T}_{re}} Q ( t ) d t = 0 \text{.83} , \qquad ( 20 )$$

where Tᵣₑ is the total post-earthquake repair time.

At step 5.2, on a basis of a bearing damage evolution curve, a pier damage evolution curve, and the traffic functionality damage evolution curve, ground motion intensities corresponding to an 85% damage rate for the bearings and piers are calculated as the minimum ground motion intensities for structural safety, denoted as PGA_{b4} and PGAₚ₄.

On a basis of separately determining the ground motion intensities at which the bearings and piers reach a damage rate of L=0.85%, the minimum ground motion intensities for structural safety, denoted as PGA_{b4} and PGAₚ₄, are 1.64 g and 1.78 g, respectively. That is, the minimum ground motion intensity required to ensure structural safety is 1.64 g.

At step 5.3, on a basis of the bearing damage evolution curve, the pier damage evolution curve, and the traffic functionality damage evolution curve, ground motion intensities corresponding to a traffic functionality loss rate reaching slight damage and an 85% damage rate are calculated as the traffic safety thresholds, denoted as PGAₜ, and PGAₜ₄, respectively.

The ground motion intensities corresponding to a traffic functionality loss rate reaching slight damage and an 85% damage rate are determined as traffic safety thresholds, with PGAₜ₁ and PGA₁₄ being 0.46 g and 1.15 g, respectively.

At step 5.4, on a basis of the ground motion intensity-seismic resilience index curve, the resilience indices R1, R2, and R3 corresponding to PGAₜ₁, PGA₄, and min(PGA_{b4}, PGAₚ₄) are calculated, respectively. In this way, three seismic resilience levels are defined, and the corresponding seismic resilience index thresholds are determined.

As shown in FIG. 24, the resilience indices R₁, R₂, and R₃ corresponding to PGAₜ₁, PGA₄, and min(PGA_{b4}, PGAₚ₄) are determined to be 0.78, 0.32, and 0.23, respectively. In the event of an earthquake, when the post-earthquake resilience of the bridge is less than 0.23, structural failure of the bridge is determined. When the post-earthquake resilience exceeds 0.23, the bridge is determined to be structurally safe. Under the condition of structural safety of the bridge, when the resilience is greater than 0.32 but less than 0.78, vehicles are permitted to travel over the bridge at restricted speeds; and when the resilience exceeds 0.78, vehicles can safely pass over the bridge.

In another embodiment, a seismic resilience assessment system for a railway girder bridge is provided, including a simulation module, a model construction module, a loss evolution analysis module, a functionality recovery analysis module, and an assessment module.

The simulation module is configured to: establish a nonlinear finite element model of the entire bridge to simulate and output seismic responses of key bridge components; and calculate, on a basis of the seismic responses of the key bridge components and a beam-track deformation mapping relationship, track alignment irregularity V, the key bridge components including piers, bearings, and tracks.

The model construction module is configured to: establish, on a basis of analysis results of piers under seismic waves, a logarithmic scatter plot between ground motion intensity and pier curvature ductility factor; establish, on a basis of bearing analysis results under the seismic waves, a logarithmic scatter plot between ground motion intensity and bearing displacement; establish, on a basis of track alignment irregularity analysis results under the seismic waves, a logarithmic scatter plot between ground motion intensity and track alignment irregularity V; and perform linear regression on the three scatter plots above to establish probabilistic seismic demand models for responses of key bridge components.

The loss evolution analysis module is configured to: calculate damage exceedance probabilities of key bridge components; normalize, on a basis of capacity thresholds, damage rate thresholds L1ᵢ, L2ᵢ, and L3ᵢ of the key bridge components; calculate bearing damage rate Q_{LB}, pier damage rate Q_{LP}, and bridge traffic functionality loss Q_{L} by weighting the damage exceedance probabilities; and establish damage evolution curves of the key bridge components under varying ground motion intensities.

The functionality recovery analysis module is configured to: obtain, according to the traffic functionality loss Q_{L}, a post-earthquake bridge residual traffic functionality Qᵣ; calculate post-earthquake component repair time Tᵣₑⱼ (j=1, 2, 3); calculate traffic function values Qᵣ₁, Qᵣ₂, and Qᵣ₃ after full recovery of each key bridge component; and finally establish, on a basis of the calculations above, post-earthquake bridge traffic functionality recovery curve.

The assessment module is configured to: obtain, on a basis of the damage evolution curves of the key bridge components and the post-earthquake bridge traffic functionality recovery curves under varying ground motion intensities, minimum ground motion intensities at which bearings and piers reach complete damage levels, and minimum ground motion intensities at which tracks reach slight damage and complete damage levels; and determine, on a basis of an ground motion intensity-seismic resilience index curve, boundary values of three seismic resilience levels of the bridge, i.e., normal passage, speed-restricted passage, and structural safety, as shown in FIG. 24.

The present disclosure has the following advantageous effects:
the present disclosure proposes a seismic resilience assessment indicator system for railway girder bridges, a method for quantifying damage states of components and traffic functionality on a basis of vulnerability, and a three-level seismic resilience classification method on a basis of resilience indices, thereby establishing a framework and procedure for the seismic resilience assessment method. The present disclosure proposes a comprehensive solution for railway girder bridges, covering the entire process from bridge design parameters, nonlinear time-history analysis, probabilistic seismic demand modeling, vulnerability analysis, traffic functionality recovery, resilience index, to three-level seismic resilience classification, thereby providing a valuable reference for pre-earthquake design and post-earthquake emergency repair decision-making.

The embodiments described above merely illustrate specific implementations of the present application. Although the description is relatively specific and detailed, it should not be construed as limiting the scope of protection of the present application. It should be noted that various modifications and improvements can be made by those of ordinary skill in the art without departing from the spirit of the technical solutions of the present application, and these shall also fall within the scope of protection of the present application.

What is claimed is:

1. A seismic resilience assessment method for a railway girder bridge, wherein the method comprises:
step 1, establishing a nonlinear finite element model of an entire bridge to simulate and output seismic responses of key bridge components; and calculating, on a basis of the seismic responses of the key bridge components and a beam-track deformation mapping relationship, track alignment irregularity V, wherein the key bridge components comprise piers, bearings, and tracks;
step 2, establishing, on a basis of pier analysis results under seismic waves, a logarithmic scatter plot between ground motion intensity and pier curvature ductility factor; establishing, on a basis of bearing analysis results under the seismic waves, a logarithmic scatter plot between the ground motion intensity and bearing displacement; establishing, on a basis of track alignment irregularity analysis results under the seismic waves, a logarithmic scatter plot between the ground motion intensity and the track alignment irregularity V; and performing linear regression on the three scatter plots above to establish probabilistic seismic demand models for responses of each key bridge component;
step 3, calculating, on a basis of the probabilistic seismic demand models for responses of each key bridge component, damage exceedance probabilities of each key bridge component under different damage states; normalizing, on a basis of capacity thresholds, damage rate thresholds of each key bridge component; calculating a bearing damage rate Q_{LB}, a pier damage rate Q_{LP}, and a bridge traffic functionality loss Q_{L} by weighting the damage exceedance probabilities and the damage rate thresholds; and establishing damage evolution curves of each key bridge component under varying ground motion intensities;
step 4, obtaining, according to the bridge traffic functionality loss Q_{L}, a post-earthquake bridge residual traffic functionality Qᵣ; calculating a post-earthquake component repair time Tᵣₑⱼ; calculating traffic functionality values Qᵣ₁, Qᵣ₂, and Qᵣ₃ after full recovery of each key bridge component; and finally establishing post-earthquake traffic functionality recovery curves; and
step 5, calculating a seismic resilience index of a bridge; obtaining, on a basis of the damage evolution curves of each key bridge component and the post-earthquake traffic functionality recovery curves under varying ground motion intensities, minimum ground motion intensities at which the bearings and the piers reach complete damage levels, and minimum ground motion intensities at which the tracks reach slight damage and the complete damage levels; and determining, on a basis of an ground motion intensity-seismic resilience index curve, boundary values of three seismic resilience levels of the bridge, wherein the three seismic resilience levels comprises normal passage, speed-restricted passage, and structural safety.

2. The seismic resilience assessment method for the railway girder bridge according to claim 1, wherein the step 1 comprises:
step 1.1, establishing, according to bridge design parameters, the nonlinear finite element model of the entire bridge;
step 1.2, determining, according to site conditions of the bridge, a target response spectrum curve;
step 1.3, selecting, on a basis of the target response spectrum curve, the seismic waves from a Pacific Earthquake Engineering Research (PEER) before inputting into the finite element model to perform nonlinear time-history analysis;
step 1.4, outputting relative displacement of a main girder end at an expansion joint, bearing deformation, and curvature φ of a cross-section at a bottom of the pier as the seismic responses of the key bridge components, wherein the relative displacement of the main girder end at the expansion joint comprises a peak displacement Dᵣ and a residual displacement Dₚ; and
step 1.5, calculating, on a basis of the beam-track deformation mapping relationship, the track alignment irregularity V.

3. The seismic resilience assessment method for the railway girder bridge according to claim 2, wherein the track alignment irregularity V is calculated as follows:
$$V ( {D}_{p} , {D}_{r} ) = {g}_{4} ( {D}_{p} ) {D}_{r}^{4} + {g}_{3} ( {D}_{p} ) {D}_{r}^{3} + {g}_{2} ( {D}_{p} ) {D}_{r}^{2} + {g}_{1} ( {D}_{p} ) {D}_{r} + {g}_{0} ( {D}_{p} ) \qquad ( 1 )$$
$$\{ \begin{matrix}{g}_{4} ( {D}_{p} ) = 1.946 \times 1 {0}^{- 7} \\ {g}_{3} ( {D}_{p} ) = - 2.091 \times 1 {0}^{- 7} {D}_{p} - 4.568 \times 1 {0}^{- 5} \\ {g}_{2} ( {D}_{p} ) = 2.247 \times 1 {0}^{- 8} {D}_{p}^{2} + 5.084 \times 1 {0}^{- 5} {D}_{p} + 0.002567 \\ {g}_{1} ( {D}_{p} ) = - 6.634 \times 1 {0}^{- 6} {D}_{p}^{2} - 0.002909 {D}_{p} + 0.5072 \\ {g}_{0} ( {D}_{p} ) = 1.234 \times 1 {0}^{- 4} {D}_{p}^{2} + 0.02334 {D}_{p} + 0.04164\end{matrix} ,$$
wherein Dᵣ is the peak displacement, Dₚ is the residual displacement, and g₀ to g₄ are intermediate calculation parameters.

4. The seismic resilience assessment method for the railway girder bridge according to claim 1, wherein the step 2 comprises:
step 2.1, performing cross-sectional analysis at the bottom of the pier to establish a cross-sectional strain-curvature curve, and obtaining an initial yield curvature φ₀ corresponding to yielding of longitudinal reinforcement of the pier;
step 2.2, calculating a curvature ductility factor pc of the pier, as shown in Equation (2),
$${μ}_{c} = \frac{φ}{{φ}_{0}} \qquad ( 2 )$$
wherein φ is a curvature of the cross-section at the bottom of the pier under seismic action, and φ₀ is a yield curvature corresponding to initial yielding of the longitudinal reinforcement of the pier;
step 2.3, taking logarithms of the ground motion intensity of each ground motion, the bearing deformation of a model under the ground motion, the curvature ductility factor of the pier, and the track alignment irregularity V, and establishing a logarithmic scatter plot between the ground motion intensity (IM) and the seismic response (EDP); and
step 2.4, performing linear regression on the logarithmic scatter plot to establish the probabilistic seismic demand models for bearings, piers, and track responses, as shown in Equation (3),
$$ln ( E D P ) = ln ( a ) + b ln ( IM ) , \qquad ( 3 )$$
wherein a and b are regression parameters of the probabilistic seismic demand model, IM is the ground motion intensity, and EDP is the seismic response.

5. The seismic resilience assessment method for the railway girder bridge according to claim 1, wherein the step 3 comprises:
step 3.1, dividing the damage states of the key bridge components into five levels, comprising no damage, slight damage, moderate damage, severe damage, and complete damage, and determining control indicators corresponding to the damage states, wherein the control indicator for the piers comprises longitudinal reinforcement strain and concrete strain, the control indicator for the bearings comprises bearing displacement, and the control indicator for the tracks comprises the track alignment irregularity; and
step 3.2, performing vulnerability analysis to calculate the damage exceedance probabilities, as shown in equations (4) and (5),
$$P = P ( E D P > {S}_{c} \vert IM ) = Φ ( \frac{ln ( E D P ) - ln ( {S}_{c} )}{\sqrt{{β}_{c}^{2} + {β}_{d}^{2}}} ) , \qquad ( 4 )$$
$${β}_{d} = \sqrt{\frac{{\sum }_{i = 1}^{N} {[ ln ( E D {P}_{i} ) - ( ln a + b \cdot ln ( IM ) ) ]}^{2}}{N - 2}} , \qquad ( 5 )$$
wherein P is the damage exceedance probability, and S_{c} is a mean seismic capacity of the key bridge component; #_{c} is a logarithmic standard deviation of a seismic capacity of the key bridge component; β_{d} is a logarithmic standard deviation of the seismic response of the key bridge component; EDPᵢ is the seismic response under an action of an i-th seismic wave; N is a number of input seismic waves; IM is the ground motion intensity; EDP is the seismic response; and a and b are regression parameters of the probabilistic seismic demand model.

6. The seismic resilience assessment method for the railway girder bridge according to claim 1, wherein the step 3 further comprises:
step 3.3, calculating the damage rate thresholds L1ᵢ, L2ᵢ, and L3ᵢ for each key bridge component, wherein Equations (6) to (8) correspond to the bearings, the piers, and the tracks, respectively,
$$L {1}_{i} = \frac{{D}_{i}}{3.3 {D}_{c}} ( i = 1 , 2 , 3 , 4 ) , \qquad ( 6 )$$
$$L {2}_{i} = \frac{{μ}_{i}}{{μ}_{4}} ( i = 1 , 2 , 3 , 4 ) , \qquad ( 7 )$$
$$L {3}_{i} = \frac{{V}_{d \_ max} - {V}_{r}}{{V}_{d \_ max} - {V}_{min}} ( i = 1 , 2 , 3 , 4 ) , \qquad ( 8 )$$
wherein D_{c} is an allowable seismic displacement of the bearing; Dᵢ is a bearing deformation threshold for an i-th damage state of the bearing; μᵢ is a sectional curvature ductility factor for an i-th damage state of the pier; V_{d_max} is a maximum design speed of a railway line, and Vₘᵢₙ is a design speed of the railway line; Vᵣ is a post-earthquake residual traffic speed; and μ₄ is a ductility factor threshold for complete damage;
step 3.4, calculating the bearing damage rate Q_{LB}, the pier damage rate Q_{LP}, and the bridge traffic functionality loss Q_{L} by weighting the damage exceedance probabilities, with reference to Equations (9) to (12),
$${Q}_{L B} = {\sum }_{i = 1}^{N} {P}_{f}^{( i )} L {1}_{i} ( i = 1 , 2 , 3 , 4 ) , \qquad ( 9 )$$
$${Q}_{L P} = {\sum }_{i = 1}^{N} {P}_{f}^{( i )} L {2}_{i} ( i = 1 , 2 , 3 , 4 ) , \qquad ( 10 )$$
$${Q}_{L} = {\sum }_{i = 1}^{N} {P}_{f}^{( i )} L {3}_{i} ( i = 1 , 2 , 3 , 4 ) , \qquad ( 11 )$$
$${P}_{f}^{( i )} = \{ \begin{matrix}{P}_{{DS}_{1}} - {P}_{{DS}_{2}} \\ {P}_{{DS}_{2}} - {P}_{{DS}_{3}} \\ {P}_{{DS}_{3}} - {P}_{{DS}_{4}} \\ {P}_{{DS}_{4}}\end{matrix} ( i = 1 , 2 , 3 , 4 ) , \qquad ( 12 )$$
wherein
$${P}_{f}^{( i )}$$
represents a damage exceedance probability function; P_{DS1}, P_{DS2}, P_{DS3}, and P_{DS4} correspond to exceedance probabilities of the slight damage, moderate damage, severe damage, and the complete damage, respectively; and
step 3.5, reaching a damage state when Q_{L} exceeds the threshold Lᵢ (i=1, 2, 3) corresponding to the damage state under a given ground motion intensity.

7. The seismic resilience assessment method for the railway girder bridge according to claim 1, wherein the step 4 comprises:
step 4.1, calculating the post-earthquake bridge residual traffic functionality Qᵣ,
$${Q}_{r} = 1 - {Q}_{L} , \qquad ( 13 )$$
step 4.2, calculating the post-earthquake component repair time Tᵣₑⱼ for the bearings, the piers, and the tracks,
$${T}_{rej} = {\sum }_{i = 1}^{4} {P}_{f}^{( i )} {T}_{i} ( j = 1 , 2 , 3 ) , \qquad ( 14 )$$
wherein
$${P}_{f}^{( i )}$$
represents a damage exceedance probability function, and Tᵢ is a repair time required for the key bridge component to reach an i-th damage state;
step 4.3, calculating traffic functionality values Qᵣ₁, Qᵣ₂, and Qᵣ₃ after full recovery of the piers, the bearings, and the tracks,
$${Q}_{r 1} = {Q}_{r} + 0.7 {Q}_{L} , \qquad ( 15 )$$
$${Q}_{r 2} = {Q}_{r} + ( 0.7 + 0.2 ) {Q}_{L} , \qquad ( 16 )$$
$${Q}_{r 3} = {Q}_{r} + ( 0.7 + 0.2 + 0.1 ) {Q}_{L} = 1 ; \qquad ( 17 )$$
and
step 4.4, establishing the post-earthquake traffic functionality recovery curve of the bridge,
$$Q ( t ) = \{ \begin{matrix}{Q}_{r} \\ {Q}_{r 1} \\ {Q}_{r 2} \\ 1\end{matrix} = \{ \begin{matrix}{Q}_{r} & {t}_{0} \leq t < {t}_{1} \\ {Q}_{r} + 0.7 {Q}_{L} & {t}_{1} \leq t < {t}_{2} \\ {Q}_{r} + ( 0.7 + 0.2 ) {Q}_{L} & {t}_{2} \leq t < {t}_{3} \\ 1 & {t}_{3} \leq t\end{matrix} , \qquad ( 18 )$$
wherein Q(t) is a function recovery function; t represents a post-earthquake time; t₀ is a repair start time; t₁ is a repair completion time of a first type of components; t₂ is a repair completion time of a second type of components; and t₃ is the repair completion time of a third type of components.

8. The seismic resilience assessment method for the railway girder bridge according to claim 7, wherein the step 5 comprises:
step 5.1, calculating the seismic resilience index R of the bridge,
$${T}_{r e} = {\sum }_{j = 1}^{3} {T}_{rej} , \qquad ( 19 )$$
$$R = \frac{1}{{T}_{re}} {\int }_{{t}_{0}}^{{t}_{0} + {T}_{re}} Q ( t ) dt , \qquad ( 20 )$$
wherein Tᵣₑ is a total post-earthquake repair time;
step 5.2, calculating, on a basis of a bearing damage evolution curve, a pier damage evolution curve, and a traffic functionality damage evolution curve, the ground motion intensities at which the bearings and the piers reach the complete damage levels as the minimum ground motion intensities for the structural safety, denoted as PGA_{b4} and PGAₚ₄;
step 5.3, calculating, on a basis of the bearing damage evolution curve, the pier damage evolution curve, and the traffic functionality damage evolution curve, the ground motion intensities at which a traffic functionality loss rate reaches the slight damage and the complete damage levels as traffic safety thresholds, denoted as PGAₜ₁ and PGAₚ₄, respectively; and
step 5.4, calculating, on a basis of the ground motion intensity-seismic resilience index curve, resilience indices R₁, R₂, and R₃ corresponding to PGAₜ₁, PGAₚ₄, and min(PGA_{b4}, PGAₚ₄), respectively as seismic resilience index thresholds corresponding to the three seismic resilience levels of the bridge.

9. The seismic resilience assessment method for the railway girder bridge according to claim 2, wherein in the nonlinear finite element model of the entire bridge in the step 1.1, the bearings are simulated using nonlinear elements, the piers are simulated using nonlinear beam-column elements, and the main girders are simulated using beam elements.

10. The seismic resilience assessment method for the railway girder bridge according to claim 4, wherein the step 2.1 comprises:
establishing a pier bottom section;
applying a vertical load to perform cross-sectional analysis at the bottom of the pier, resulting in the cross-sectional strain-curvature curve, and obtaining the initial yield curvature φ₀ corresponding to a first yield of the longitudinal reinforcement of the pier.

11. The seismic resilience assessment method for the railway girder bridge according to claim 1, after determining, on the basis of the ground motion intensity-seismic resilience index curve, the boundary values of three seismic resilience levels of the bridge, the method further comprises:
predicting vulnerable locations and a number of vulnerable components of the entire bridge after an earthquake under different seismic levels according to the boundary values of three seismic resilience levels of the bridge;
determining a post-earthquake repair plan for the railway girder bridge based on the vulnerable locations and the number of components.

12. The seismic resilience assessment method for the railway girder bridge according to claim 1, after determining, on the basis of the ground motion intensity-seismic resilience index curve, the boundary values of three seismic resilience levels of the bridge, the method further comprises:
determining a seismic resilience state of the railway girder bridge under different earthquake levels according to the boundary values of three seismic resilience levels of the bridge;
adjusting seismic resilience design parameters of the railway girder bridge according to the seismic resilience state.

13. The seismic resilience assessment method for the railway girder bridge according to claim 1, after determining, on the basis of the ground motion intensity-seismic resilience index curve, the boundary values of three seismic resilience levels of the bridge, the method further comprises:
determining whether the railway girder bridge is passable for trains after an earthquake at different seismic levels according to the boundary values of three seismic resilience levels of the bridge.
